(19) United States
(12) Patent Application Publication
(10) Pub. No.: US 2026/0285337 A1
(43) Pub. Date: Sep. 24, 2026

(54) POWER CONTROL FOR VEHICLES

(71) Applicant: VOLVO TRUCK CORPORATION, Göteborg (SE)

(72) Inventors: Mats JONASSON, Partille (SE); Umur ERDINC, Göteborg (SE)

(73) Assignee: VOLVO TRUCK CORPORATION, Göteborg (SE)

(21) Appl. No.: 19/474,367

(22) PCT Filed: Apr. 13, 2023
(86) PCT No.: PCT/EP2023/059643

§ 371 Date: Oct. 10, 2025

(51) Int. Cl. B60W 50/06; B60W 10/04; B60W 10/184

(52) U.S. Cl. CPC B60W 50/06; B60W 10/04; B60W 10/184; B60W 2300/145; B60W 2300/147; B60W 2520/105; B60W 2520/12; B60W 2520/14; B60W 2540/18

(57) ABSTRACT

A computer-implemented method determines a force control input for a vehicle combination comprising a tractor unit and at least one trailing unit. The method includes receiving a reference input representing a requested movement of the vehicle combination, determining a requested force input for one or more units of the vehicle combination from the reference input, determining a requested state of energy rate for one or more units of the vehicle combination, determining a state of energy rate allocated to one or more units of the vehicle combination, determining respective power losses associated with one or more units of the vehicle combination. The power losses are a function of a force provided by the unit. The force control input is determined such that a sum for the vehicle combination of a cumulative power loss and a cumulative difference between the requested state of energy rate and the allocated state of energy rate is below a threshold. The determined force control input meets the reference input for the vehicle combination.

### CROSS-REFERENCE TO RELATED APPLICATIONS

This application is a U.S. National Stage application of PCT/EP2023/059643, filed Apr. 13, 2023 and published on Oct. 17, 2024, as WO/2024/213248, all of which is hereby incorporated by reference in its entirety.

### TECHNICAL FIELD

The disclosure relates generally to vehicle control. In particular aspects, the disclosure relates to power control for vehicles, in particular determining a force control input for a vehicle combination based on power losses and state of energy rate differences associated with units of the vehicle combination. The disclosure can be applied in heavy-duty vehicles, such as trucks, buses, and construction equipment. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

In vehicle motion management, a control system of a vehicle combination may determine control signals for actuators of the vehicle combination in order to satisfy the requested global forces of the vehicle combination. For example, the control system may receive an input related to a manoeuvre for the vehicle combination and determine control signals in the form of propulsion and braking instructions that meet the requested global forces of the vehicle combination subject to certain constraints, for example energy and safety constraints.

In traditional vehicle combinations, for example semi-trailers, a tractor unit may provide propulsion for the entire combination, while trailing units are towed behind. Traditional vehicle combinations may employ internal combustion engines in a tractor unit to provide propulsion. In battery electric vehicle combinations, batteries may be installed in the tractor unit to power electric motors and provide propulsion. If batteries are also installed in the trailer of a vehicle combination, electrical motors may also be installed so that the trailer can be used as a propulsive complement to the combination. This allows the use of an electric trailer with both tractors having internal combustion engines and battery electric vehicle tractors. Furthermore, conventional heavy vehicle trailers are normally installed with pneumatic brakes to make the vehicle stop safely and in time. An electric trailer could also be used to recharge the batteries through regenerative braking, thus preventing wasting energy through the mechanical braking system.

One issue with vehicle combinations that operate in this way is that power losses resulting from the force allocation of typical vehicle motion management approaches may be relatively large (or at least not optimal).

It is therefore desired to develop a solution for vehicle motion management that addresses or at least mitigates some of these issues.

WO 2022/106004 A1 discloses predictive energy and motion management for multi-trailer heavy-duty vehicles. A method for controlling motion of a heavy-duty vehicle is disclosed, comprising determining a vehicle motion profile for performing a vehicle manoeuvre as a solution to a non-linear optimal control problem constrained by lateral and longitudinal wheel slip limits and formulated to account for a road friction coefficient and/or curvature along the upcoming vehicle path.

US 2022/332194 A1 discloses a control interface for inefficient electric machines. A method is disclosed for controlling an electric machine (EM) of a heavy-duty vehicle comprising an energy storage system (ESS) connected to the EM, the method comprising obtaining an energy absorption capability of the ESS, determining an amount of regenerated energy by the EM during braking, and configuring an efficiency level of the EM in dependence of the energy absorption capability of the ESS relative to the amount of regenerated energy by the EM during braking.

### SUMMARY

This disclosure attempts to address the problems noted above by providing methods for determining a force control input for a vehicle combination based on power losses and state of energy rate differences associated with units of the vehicle combination. In particular, a force control input for the vehicle combination is determined that meets a reference force input whilst ensuring that cumulative power losses of the vehicle combination and a difference between requested state of energy rates and allocated state of energy rates across the vehicle combination are below a threshold. This provides a force control input for vehicle motion management that enable higher efficiency of operation of the vehicle combination as well as ensuring that energy management, such as state of charge of the various batteries, is properly performed.

According to an aspect of the disclosure, there is provided a computer-implemented method for determining a force control input for a vehicle combination comprising a tractor unit and at least one trailing unit, the method comprising, by processing circuitry of a computer system, receiving a reference input representing a requested movement of the vehicle combination, determining a requested force input for one or more units of the vehicle combination from the reference input, determining a requested state of energy rate for one or more units of the vehicle combination, determining a state of energy rate allocated to one or more units of the vehicle combination, determining respective power losses associated with one or more units of the vehicle combination, wherein the power losses are a function of a force provided by the unit, and determining the force control input such that a sum for the vehicle combination of a cumulative power loss and a cumulative difference between the requested state of energy rate and the allocated state of energy rate is below a threshold, wherein the determined force control input meets the reference input for the vehicle combination.

This method enables a reference force input to be met whilst ensuring efficient and accurate operation of the vehicle combination. In particular, power losses and a state of energy rate difference of the vehicle combination can be minimised to the extent allowed when the reference input is met. This can be done by considering each unit of the vehicle combination, such that an optimal force control input for the whole combination is determined.

Optionally, the power losses associated with a unit comprise power losses for the propulsion system of the unit and/or power losses for the braking system of the unit. This enables the different losses that occur during different motions of the vehicle combination to be taken into account, rather than focusing solely on one of these motions.

Optionally, the power losses associated with a unit comprise at least one of a power loss associated with a battery of the unit, a power loss associated with an electrical machine of the unit, a power loss associated with the drivetrain of the unit, and a power loss associated with service brakes of the unit. This ensures that all losses from different components of a unit are taken into account when assessing the losses of the unit as a whole.

Optionally, the difference between the requested state of energy rate and the allocated state of energy rate for a unit comprises a difference for the propulsion system of the unit and a difference for the braking system of the unit. This ensures the resulting state of energy rate adheres accurately to the requested state of energy rate during different motions of the vehicle combination, rather than focusing solely on one of these motions.

Optionally, the force control input comprises a force control input for each unit of the vehicle combination. This enables the force control input to be specified for each unit, rather than simply providing a force control input for the vehicle combination as a whole, which enables different configurations to be achieved to reduce the overall power losses.

Optionally, the force control input comprises a force control input for the propulsion system of at least one unit of the vehicle combination and a force control input for the braking system of at least one unit of the vehicle combination. This enables the force control input to be specified for different motions of the vehicle combination, rather than focusing solely on one of these motions.

Optionally, the computer-implemented method comprises determining the force control input using an optimisation function to minimise a sum of the total power losses and the state of energy rate difference of the vehicle combination. This enables different solutions to be found in an efficient manner that minimises the total power losses and the state of energy rate difference.

Optionally, the optimisation function is given by:

$${min}_{F} {\sum }_{i = 1}^{n} ( {P}_{pi , loss} ( {F}_{pi} ) + {P}_{bi , loss} ( {F}_{bi} ) + {( {\dot{SoE}}_{i , req} - {\dot{SoE}}_{i} )}^{2} )$$

Where, for each unit i, P_{pi,loss} is the power loss for propulsion, a P_{bi,loss} is the power loss for braking, Fₚᵢ is a force control input for the unit's propulsion system, F_{bi} is a force control input for the unit's braking system, S\dot{o}E_{i,req} is the requested state of energy rate, S\dot{o}Eᵢ is the allocated state of energy rate, and F=[Fₚᵢ, F_{bi}].

Optionally, the optimisation function is constrained by the force capabilities of the units of the vehicle combination. This ensures that the resulting force control input is capable of being implemented by the vehicle combination, for example by the actuators of the units of the vehicle combination.

Optionally, the optimisation function is constrained by a safe operating envelope of the vehicle combination. This ensures that the resulting force control input maintains the motion of the vehicle combination within safe limits, this avoiding issues such as yaw instabilities.

Optionally, the optimisation function comprises weighting factors associated with one or more units of the vehicle combination. This enables the resulting force control input to be tuned for different operating conditions and outcomes.

Optionally, the weighting factors comprise weighting factors for the unit's propulsion system and weighting factors for the unit's braking system. This enables the resulting force control input to be tuned for different motions and for different operating conditions and outcomes.

Optionally, the weighting factors are determined based on current or future operating conditions of the vehicle combination. This enables the resulting force control input to be tuned based on different phases of motion of the vehicle combination.

Optionally, the optimisation function comprises a term for the difference between requested forces and allocated forces across the vehicle combination. This ensures that the resulting force adheres accurately to the requested force input.

Optionally, the reference input comprises at least one of a longitudinal acceleration of the vehicle combination, a longitudinal acceleration of at least one a unit, a longitudinal velocity of the tractor unit a lateral velocity of the tractor unit, a yaw rate of at least one unit of the vehicle combination, and a steering angle of the tractor unit. This enables different aspects of the motion of the vehicle combination to be considered when determining an appropriate force control input.

According to another aspect of the disclosure, there is provided a vehicle combination comprising a tractor unit and at least one trailing unit, the vehicle combination comprising processing circuitry to perform the computer-implemented method.

According to another aspect of the disclosure, there is provided a computer program product comprising program code for performing, when executed by processing circuitry, the computer-implemented method.

According to another aspect of the disclosure, there is provided a control system comprising one or more control units configured to perform the computer-implemented method.

According to another aspect of the disclosure, there is provided a non-transitory computer-readable storage medium comprising instructions, which when executed by processing circuitry, cause the processing circuitry to perform the computer-implemented method.

According to another aspect of the disclosure, there is provided a computer system comprising processing circuitry configured to perform the computer-implemented method.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above-discussed technical benefits.

### BRIEF DESCRIPTION OF THE DRAWINGS

With reference to the appended drawings, below follows a more detailed description of aspects of the disclosure cited as examples.

FIG. 1 schematically shows a side view of an example vehicle combination.

FIG. 2 schematically shows a top-view of an example vehicle combination.

FIG. 3 schematically shows, in terms of functional blocks, an example control system for a vehicle combination.

FIG. 4 schematically shows an example power flow model for a vehicle combination.

FIG. 5 is a flowchart of an example method for controlling a vehicle combination.

FIG. 6 is a flowchart of another example method for controlling a vehicle combination.

FIG. 7 is a flowchart of another example method for controlling a vehicle combination.

FIG. 8 is a schematic diagram of an exemplary computer system for implementing examples disclosed herein, according to one example.

FIG. 9 is a schematic drawing of a computer readable medium according to one example.

FIG. 10 is a schematic block diagram of a control unit according to one example.

Like reference numerals refer to like elements throughout the description.

### DETAILED DESCRIPTION

Aspects and examples set forth below represent the necessary information to enable those skilled in the art to practice the disclosure.

In vehicle combinations having a plurality of units, for example a tractor unit and one or more trailer units, power losses are present at various levels of the system. Power losses may be present in both propulsion systems and braking systems of a vehicle combination. For example, power losses may be present at actuators of the vehicle combination, such as internal combustion engines, electrical machines and service brakes associated with the different units of the vehicle combination. Power losses may also be present at other parts of the vehicle combination, such as the batteries and the drivetrain of the vehicle combination. Many vehicle motion management approaches do not adequately take these losses into account, and simply changing force distribution across the vehicle combination to reduce power losses does not take into account other important factors such as vehicle stability or accurate reproduction of the requested inputs.

To remedy this, methods and systems are proposed for determining a force control input for a vehicle combination that meets a reference force input whilst ensuring that cumulative power losses of the vehicle combination and a difference between requested state of energy rates and allocated state of energy rates across the vehicle combination are below a threshold. This provides a force control input for vehicle motion management that enable higher efficiency of operation of the vehicle combination whilst meeting requested state of energy rates.

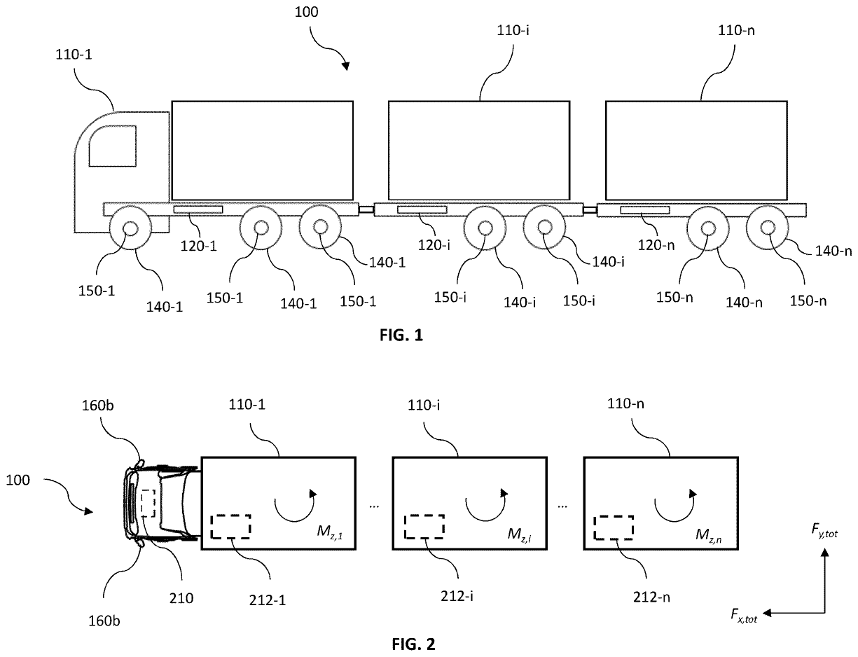

FIG. 1 schematically shows a side view of an example vehicle combination 100 of the type considered in this disclosure. The vehicle combination 100 comprises a number of units 110, including a tractor unit and at least one trailing unit. Each unit 110 may be given an index i, and the total number of units 110 in a vehicle combination 100 is designated n. Whilst two trailing units are shown, it will be appreciated that the vehicle combination 100 may comprise more or fewer trailing units connected to each other. This gives rise to different types and designations of vehicle combinations.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power for the vehicle combination 100. In the example of FIG. 1, the tractor unit 110-1 may also be used to store goods that are being transported by the vehicle combination 100.

A trailing unit, such as the trailing units 110-i, 110-n, is generally used to store goods that are being transported by the vehicle combination 100. A trailing unit may be a truck, trailer, dolly and the like. A trailing unit may also provide propulsion to the vehicle combination 100. A trailing unit without a front axle, such as the trailing units 110-i, 110-n, is known as a semi-trailer. In vehicle combinations such as that shown in FIG. 1, vehicle motion management is available on a unit level to receive requests from a manual or virtual driver to coordinate the propulsion, braking and steering. All units 110 may provide propulsion to the vehicle combination 100.

Whilst three tractor axles and two axles per trailer are shown, it will be appreciated that any suitable number of axles may be provide on the respective units 110. It will also be appreciated that any number of the tractor axles and/or trailer axles may be driven axles, including zero (i.e. one of the units may include at least one driven axle while the other does not).

The vehicle combination 100 may comprise one or more sources or propulsion. For example, on or more of the units 110 may comprise one or more electrical machines 130 (not shown) such as electric motors. Each unit 110 may comprise one or more batteries 120 configured to provide power to the electrical machines 130. In some examples, a unit 110, most often a tractor unit 110-1, may also include another source of propulsion, for example an internal combustion engine (ICE). The vehicle combination 100 also comprises a drivetrain (not shown) to deliver mechanical power from the propulsion source (the electrical machines 130 or the ICE) to the wheels 140.

The electrical machines 130 are configured to drive, e.g. provide torque and/or steering to, one or more axles or individual wheels 140 of the unit 110. The electrical machines 130 of a unit 110 can supply either a positive (propulsion) or negative (braking) force. In some examples, electric motors may also be operated as generators, in order for the electric motors to generate braking force when required. The use of electrical machines 130 to supply a negative force is known as regenerative braking. The energy recovered from regenerative braking can be stored in the batteries 120, and so regenerative braking is generally preferred over using service brakes 150.

Furthermore, each unit 110 may comprise one or more sets of service brakes 150. The service brakes 150 of a unit 110 can supply a negative (braking) force. The service brakes 150 may be, for example, frictional brakes such as pneumatic brakes. Pneumatic brakes use a compressor to fill the brake with air, which may be powered by the batteries 120. In some examples, the brakes may be electro-mechanical brakes.

The ICE, electrical machines 130 and service brakes 150 are considered as actuators of the vehicle combination 100. Other actuators may also be present, such as steering servo arrangements. Each actuator in a given unit 110 may be given an index k, and the total number of actuators in a given unit 110 is designated m.

The vehicle combination 100, or indeed one or more (e.g. each) units 110, can be considered to comprise two systems: a propulsion system comprising the components that are involved in propulsion of the vehicle combination 100, and a braking system comprising the components that are involved in braking of the vehicle combination 100. As such, the propulsion system can be considered to comprise one or more of the ICE, electrical machines 130, the drivetrain, and batteries 120 of the vehicle combination 100, while the braking system can be considered to comprise the electrical machines 130, the drivetrain, the batteries 120, and the service brakes 150. As such, there is some overlap between the propulsion system and the braking system.

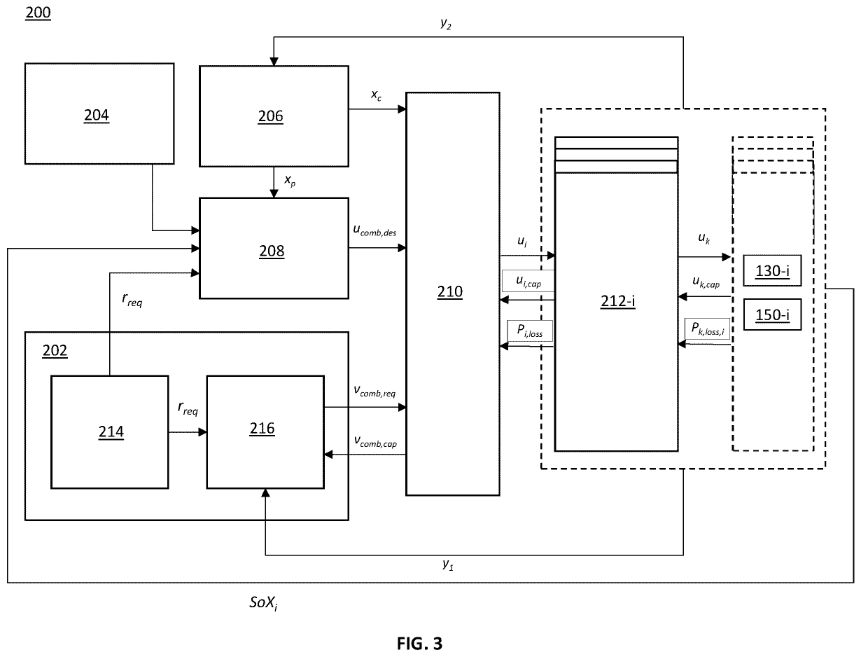

FIG. 2 schematically shows a top-view of an example vehicle combination 100 of the type considered in this disclosure. Similarly to the example of FIG. 1, the vehicle combination 100 comprises a number of units 110, including a tractor unit and a plurality of trailing units. FIG. 2 also shows the requested global forces of the vehicle combination 100 as a whole. Examples of requested global forces of the vehicle combination 100 as a whole may e.g. include a total longitudinal/axial force F_{x.tot} a total lateral/radial force F_{y,tot}, and/or one or more yaw moments M_{z,i} for the respective vehicle units 110. In order to control motion of a vehicle combination 100, the requested global forces of the vehicle combination 100 must be determined and resolved. This may be achieved by a control system 200 (shown in FIG. 3) of the vehicle combination 100 that determines control signals based on a requested reference input and certain operating conditions of the vehicle combination 100.

In the example of FIG. 2, the vehicle combination 100 includes a combination control allocator 210 and a plurality of unit control allocators 212. The combination control allocator 210 and the various unit specific control allocators 212 together form a distributed control allocation system for the vehicle combination 100. In this system, the control allocation may be performed on multiple levels, i.e. first on a level of the vehicle combination 100 as a whole, and then on a level of each vehicle unit 110 individually. The combination control allocator 210 may be provided (as shown) as part of the tractor unit 110-1, while the unit control allocators 212 are provided as part of each individual unit 110. It will be appreciated that the combination control allocator 210 may be provided as part of any unit 110 of the vehicle combination 100.

FIG. 3 schematically shows, in terms of functional blocks, an example control system 200 for a vehicle combination 100. The control system 200 serves to perform various functions of the vehicle combination 100, such as power management and motion coordination. The control system 200 comprises a target generator 202, a tactical layer 204, a state estimator 206, an energy manager 208, a combination control allocator 210 and a plurality of unit control allocators 212. The various modules may e.g. be implemented as code running on a processing circuitry, or similar. The various modules may be communicatively connected or connectable to each other, for example as known in the art.

The purpose of the target generator 202 is to determine a requested reference input r_{req} and a virtual control input V_{comb,req} for the vehicle combination 100. The requested reference input r_{req} is determined based on an input related to a manoeuvre for the vehicle combination 100 and represents a requested movement of the vehicle combination 100. The virtual combination control input V_{comb,req} is determined based on the requested reference input r_{req} and a motion capability V_{comb,cap} for the vehicle combination 100. The target generator 202 comprises a path planner/controller 214 and a force generator 216.

The target generator 202 may receive an input related to a manoeuvre for the vehicle combination 100. The manoeuvre may be, for example, straight-line driving, cornering, braking and the like. The target generator 202 may receive a signal from, for example, a steering wheel and/or gas/brake pedal of the combination 100, indicating that the driver (or some other system of the vehicle combination 100) wants to change the direction and/or the speed of the vehicle combination 100 in a certain way. In some examples, the signal may originate from elsewhere, for example any other system that may provide some indication of how the overall forces of the vehicle combination 100 are to be influenced (e.g. steered, propelled or braked). For example, the signal may originate from a lane assist system, a lane following system, an emergency steering system, an emergency braking system, an automated or semi-automated drive system. Based on this input, the target generator 202 outputs a requested reference input r_{req}. In particular, the path planner/controller 214 determines the requested reference input r_{req}. The requested reference input r_{req} may comprise at least one of a longitudinal acceleration aₓ of the vehicle combination 100 as a whole or of a unit 110 of the vehicle combination 100 (for example the unit 110 comprising the combination control allocator 210), a longitudinal velocity vₓ₁ of the tractor unit 110-1, a lateral velocity v_{y1} of the tractor unit 110-1, a yaw rate ω_{zi} of at least one unit 110 of the vehicle combination 100, and a steering angle δ_{f, reg} of the tractor unit 110-1.

The virtual combination control input V_{comb,req} is determined based on the requested reference input r_{req}. In particular, the force generator 216 determines the virtual combination control input V_{comb,req}. The virtual combination control input V_{comb,req} may include requested motion parameters for the vehicle combination 100. In particular, the forces F_{tot,req} and/or moments M_{z,tot,req} that need to be applied to the vehicle combination 100 as a whole in order to follow the requested reference input r_{req} are determined. The requested motion parameters included in the combination virtual control input V_{comb,req} of the vehicle combination 100 may comprise at least one of a longitudinal force F_{x,tot,req} of the vehicle combination 100, a lateral force F_{y,tot,req} of the vehicle combination 100, a longitudinal coupling force F_{cxi,req} between consecutive units 110, a lateral coupling force F_{cyi,req} between consecutive units 110. These make up the total force to be applied F_{tot,req} for the vehicle combination 100. The requested motion parameters included in the combination virtual control input V_{comb,req} of the vehicle combination 100 may comprise a yaw moment M_{z,i,req} for one or more units 110.

The virtual combination control input V_{comb,req} may also be determined based on state information y₁ from the different units 110 of the vehicle combination 100 and a motion capability V_{comb,cap} for the vehicle combination 100. The state information y₁ may include information from sensors of the vehicle combination 100 such as wheel speed sensors, inertial measurement units, articulation angle sensors and the like. The motion capability V_{comb,cap} of the vehicle combination 100 may describe the limits of motion parameters for safe operation of the vehicle combination 100. The motion capability V_{comb,cap} may comprise at least one of a longitudinal force F_{x.tot,cap} of the vehicle combination 100, a lateral force F_{y,tot,cap} of the vehicle combination 100, and a yaw moment M_{z,i,cap} for one or more units 110.

The virtual combination control input V_{comb,req} may be determined based on a vehicle model. The vehicle model can be any suitable model, for example a model known in the art. The model can be based on real tests, computer model simulations, a machine-learning model, or other suitable means known in the art. The vehicle model may provide motion prediction of the vehicle combination 100 by looking at previous steering input and acceleration input. The prediction may include instabilities such as understeer or rollover risk, for example within a one second horizon. The model may be, for example, a single-track model, i.e., left and right wheels on a given axle are considered together. The real units can have axle groups with several axles, but in the model they are considered together. A tyre model can be used in combination with the vehicle model. The tyre model may take into account the cornering stiffness of the tyres of the vehicle combination 100.

The tactical layer 204 is responsible for ensuring that the trajectory for the whole combination 100 is obstacle free and collision free. The tactical layer 204 may also provide a requested reference input in an autonomous driving case. The tactical layer 204 may also include predictive energy management, including battery targets, capabilities and statuses that determine how the energy sources of the vehicle combination 100 should be used for a whole mission.

In some examples, the tactical layer 204 can decide on state of charge (SoC) targets for the batteries 120 of the vehicle combination 100 as a function of distance, in some cases considering slope changes, etc. For example, the tactical layer 204 can request the battery 120 of a unit 110 having a higher SoC be drained for an uphill slope, as it can foresee that batteries 120 of all units 110 can be charged fully with regenerative braking at a following downhill slope. In some examples, an SoC controller (not shown) can calculate weighting factors for SoC targets. In some examples, the tactical layer 204 can send targets for the state of energy rate (SoE) directly to the combination control allocator 210.

Furthermore, the tactical layer 204 can request the transfer of energy from one unit 110 to another by means of propulsion in one unit 110 and regenerative braking in the other (as explained in WO 2021/180300 A1 in the name of Volvo Truck Corporation). In another example, the tactical layer 204 request the battery 120 of a unit 110 be drained faster than another based on the number of available chargers in a following charge station or due to equalizing the charging time of all units 110 or minimizing the total charging time at the charging station.

The state estimator 206 is responsible for processing state information y₂ from the different units 110 of the vehicle combination 100. For example, the state estimator 206 may receive information from sensors of the vehicle combination 100 such as wheel speed sensors, inertial measurement units, articulation angle sensors and the like and use this information to determine states for the vehicle combination 100 and the various units. The state estimator 206 may then output unit-specific state information xₚ to the energy manager 208 and unit-specific state information xc to the combination control allocator 210.

The energy manager 208 determines a power split between the different units 110 of the vehicle combination 100. The energy manager 208 may also determine a power split within each unit 110, meaning how the power demand is divided between the actuators (for example, the ICE, the electrical machines 130, service brakes 150, and/or steering servo arrangements) of the unit 110. Inputs to the energy manager 208 include the requested reference input r_{req} from the target generator 202 and the statuses SoX of the batteries 120 of the vehicle combination 100. The energy manager 208 determines a power allocation and an associated power allocation input u_{comb,des}. The power split may be determined based on the state of energy rate (S\dot{o}E) for each unit 110 and/or the longitudinal part of the requested force for the unit's propulsion system F_{xpi,req}. The energy manager 208 may consider factors that affect long-term energy consumption, such as road slopes, SoC states, charger locations, and the like, and determine power behavior as a function of the energy over time.

Based on these values, the control allocators 210, 212 may determine control signals that meet the requested global forces of the vehicle combination 100 to meet certain constraints, such as power management (optimising battery usage) and safety constraints (ensuring that the trajectory for the whole combination 100 is obstacle free and collision free). In particular, the control allocators 210, 212 determine how various actuators (for example, the ICE, the electrical machines 130, service brakes 150, and/or steering servo arrangements) of the vehicle combination 100 are to be controlled in order to generate requested global forces of the vehicle combination 100 as a whole. The combination control allocator 210 and the various unit specific control allocators 212 together form a distributed control allocation system for the vehicle combination 100. In this system, the control allocation is performed on multiple levels, i.e. first on a level of the vehicle combination 100 as a whole, and then on a level of each vehicle unit 110 individually.

The combination control allocator 210 transforms the virtual combination control input V_{comb,req} from the target generator 202 into a true control input u_{comb} for the vehicle combination 100, describing appropriate motion parameters for each unit 110. The combination control allocator 210 also transforms the true combination control input u_{comb} into unit-specific virtual control inputs uᵢ describing the forces that each respective unit 110 is to produce in order to provide the true control input u_{comb} of the vehicle combination 100. The true control input u_{comb} of the vehicle combination 100 comprises the force F to be applied for the vehicle combination 100. The unit-specific virtual control inputs uᵢ may comprise a virtual force control input for the unit's propulsion system F_{pi,req} and a virtual force control input for the unit's braking system F_{bi,req}.

The unit control allocators 212 comprise a specific control allocator 212 for each unit 110 of the vehicle combination 100. The unit-specific virtual control inputs uᵢ that are output from the combination control allocator 210 are transformed into unit-specific true control inputs uₖ, describing actual actuator commands by the unit-specific control allocators 212. For example, the unit-specific control allocators 212 map the forces and moments of each unit 110 into the steering and drive/brake torques to be applied at the wheels 140 of each unit 110. To do this, the unit control allocators 212 determine virtual force control inputs for the individual actuators of the unit's different systems: F_{pk,req} for the actuators of the propulsion system, and F_{bk,req} for the actuators of the braking system. The unit control allocators 212 then determine the unit-specific true control inputs uₖ accordingly, which comprise a true force control input for the unit's propulsion system Fₚᵢ and a true force control input for the unit's braking system F_{bi}. These may respectively include true force control inputs for the individual actuators of a unit: Fₚₖ for the unit's propulsion actuators and F_{bk} for the unit's braking actuators.

In some examples, each unit 110 may be capable of estimating its own capabilities u_{i,cap}, e.g. how much and/or how fast the unit can move at a current time instant. The unit capabilities comprise a force capability for its propulsion system F_{pi,cap} and a force capability for its braking system F_{bi,cap}. This may be based on an actuator capability u_{k,cap} for each actuator, e.g. how much and/or how fast the unit can move at a current time instant. The actuator capabilities comprise a force capability for the actuators F_{pk,cap} during propulsion and a force capability for the actuators F_{bk,cap} during braking. The actuators of each unit 110 may provide an actuator capability u_{k,cap} to the respective unit control allocator 212-i, which provides a unit capability u_{i,cap} to the combination control allocator 210. The unit capabilities u_{i,cap} may also comprise capabilities of the power input/output of the batteries 120.

Each unit 110 may also be capable of estimating its own power losses P_{i,loss}. The unit power losses P_{i,loss} comprise a power loss for its propulsion system P_{pi,loss} and a power loss for its braking system P_{bi,loss}. This may be based on an actuator power losses P_{k,loss,i} for each actuator in the unit as well as other power losses in the unit 110, such as power losses in the batteries and the drivetrain. The actuator power losses P_{k,loss,i} comprise a power loss for propulsion actuators P_{pk,loss,i} (e.g. electrical machines 130, ICE, and/or other propulsion sources) and a power loss for braking actuators P_{bk,loss,i} (e.g. electrical machines 130 and/or service brakes 150). The actuators of each unit 110 may provide the actuator power losses P_{k,loss,i} to the respective unit control allocator 212-i, which provides unit power losses P_{i,loss} to the combination control allocator 210.

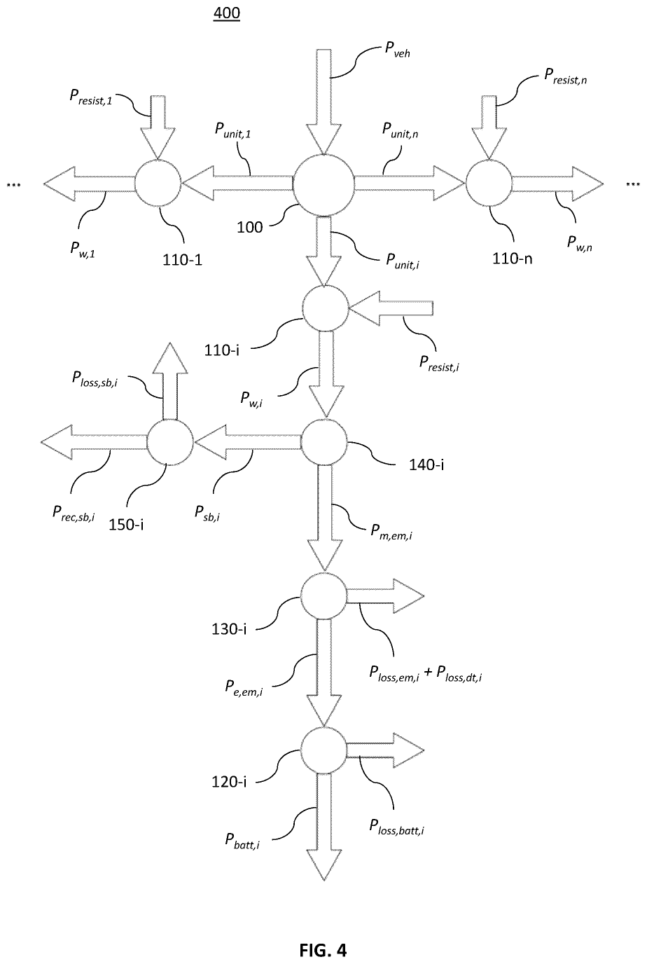

FIG. 4 shows an example power flow model 400 for a vehicle combination 100 that includes the power losses present across the combination. The power flow model 400 divides the total power demand Pᵥₑₕ required for the vehicle combination 100 to perform a certain manoeuvre across the various units 110. The power demand Pᵥₑₕ may be determined by multiplying the overall requested force F_{tot,req} by the current velocity of the vehicle combination 100.

The power demand Pᵢ for a unit 110 is split into the power P_{w,i} to be delivered at the wheels 140 of the unit 110 and the power losses P_{resist,i} due to resistive forces such as air resistance, friction, and the like. For the purposes of this disclosure, the power losses P_{resist,i} due to resistive force are not considered as part of the power losses of the unit 110. Furthermore, the model considers only power delivered by the electrical machines 130, though it will be appreciated that power may delivered by an ICE, which would have associated losses.

The power P_{w,i} to be delivered at the wheels 140 of each unit 110 is split into the mechanical power P_{m,em,i} delivered by the electrical machines 130 and the power P_{sb,i} delivered by the service brakes 150 during braking.

The power P_{m,em,i} delivered by the electrical machines 130 of each unit 110 is split into the electrical power P_{e,em i} delivered from the batteries 120-i, power losses P_{loss,em,i} from the electrical machines 130-i, including losses from inverters coupled to the electrical machines 130-i, and power losses from the drivetrain P_{loss,dt,i}. The electrical power P_{e,em,i} delivered from the batteries 120 of each unit 110 is split into the actual power P_{batt,i} delivered from the batteries 120 and power losses P_{loss,batt,i} from the batteries 120 including any converter. The actual power P_{batt,i} may be comprised of two components: a power P_{batt,I,P>0} delivered from the batteries 120 during propulsion, and a power P_{batt,I,P<0} recovered by the batteries 120 during regenerative braking.

The power P_{sb,i} delivered by the service brakes 150 of each unit 110 is split into the thermal recovery power P_{rec,sb,i} from the service brakes 150-i, and power losses P_{loss,sb,i} from the service brakes 150-i. The power losses P_{loss,sb,i} from the service brakes 150 are principally heat losses. With pneumatic brakes, there may also be losses from the compressor. The thermal recovery power P_{rec,sb,i} from the service brakes 150 is a result of regenerative braking, where the kinetic energy of a braking vehicle that would otherwise be lost as heat is converted into a useful form. In current systems, the thermal recovery power P_{rec,sb,i} from the service brakes 150 is often zero.

A detailed description of the power flow model 400 and its use for determining a power allocation for the vehicle combination 100 is disclosed in PCT patent applications PCT/EP2022/082326, PCT/EP2022/08237, and PCT/EP2022/082338, which were filed in the name of Volvo Truck Corporation on 17 Nov. 2022.

It is apparent from the power flow model 400 that there are four principal sources of power loss P_{i,loss} in the units 110 of the vehicle combination 100: power losses P_{loss,batt,i} from the batteries 120-i, power losses P_{loss,em,i} from the electrical machines 130-i, power losses P_{loss,dt,i} from the drivetrain, and power losses P_{loss,sb i} from the service brakes 150-i. The power losses from the electrical machines 130-i, and the service brakes 150 can be collectively referred to as the actuator losses P_{k,loss,i}. The following expressions can therefore be formulated for a unit i:

$${P}_{i , loss} = {P}_{loss , batt , i} + {P}_{loss , dt , i} + {\sum }_{k = 1}^{m} {P}_{k , loss , i} \qquad ( 1 )$$

$${\sum }_{k = 1}^{m} {P}_{k , loss , i} = {P}_{loss , sb , i} + {P}_{loss , em , i} \qquad ( 2 )$$

As discussed above, the unit power losses P_{i,loss} comprise a power loss for the unit's propulsion system P_{pi,loss} and a power loss for the unit's braking system P_{bi,loss}. Therefore, expression (1) can be reformulated as follows:

$${P}_{pi , loss} = {P}_{p , loss , batt , i} + {P}_{p , loss , dt , i} + {\sum }_{k = 1}^{m} {P}_{pk , loss , i} \qquad ( 3 )$$

$${P}_{bi , loss} = {P}_{b , loss , batt , i} + {P}_{b , loss , dt , i} + {\sum }_{k = 1}^{m} {P}_{bk , loss , i} \qquad ( 4 )$$

where P_{p,loss,batt,i} is the power loss from the batteries 120 during propulsion, P_{b,loss,batt,i} is the power loss from the batteries 120 during braking, P_{p,loss,dt,i} is the power loss from the drivetrain during propulsion, P_{b,loss,dt,i} is the power loss from the from the drivetrain during braking. It should be noted that there are no battery losses in braking when only the service brakes 150 are used. Similarly, the actuator power losses P_{k,loss,i} comprise a power loss for propulsion actuators P_{pk,loss,i} and a power loss for braking actuators P_{bk,loss,i}. Therefore, expression (2) can be reformulated as follows:

$${\sum }_{k = 1}^{m} {P}_{pk , loss , i} = {P}_{p , loss , em , i} \qquad ( 5 )$$

$${\sum }_{k = 1}^{m} {P}_{bk , loss , i} = {P}_{b , loss , sb , i} + {P}_{b , loss , em , i} \qquad ( 6 )$$

where P_{p,loss,em,i} is the power loss from the electrical machines 130 during propulsion, P_{b,loss,em,i} is the power loss from the electrical machines 130 during braking, and P_{b,loss,sb,i} is the power loss from the service brakes 150 during braking. Note that there is no power loss from the service brakes 150 during propulsion.

The power losses for a unit 110 P_{i,loss} are a function of the force Fᵢ applied at the unit 110. The force Fᵢ applied at the unit 110 comprises a force applied by the unit's propulsion system Fₚᵢ, which is based on the force control input for the propulsion system F_{pi,req}. The force Fᵢ applied at the unit 110 also comprises a force applied by the unit's braking system F_{bi}, which is based on the force control input for the braking system F_{bi,req}. As such, the total power losses P_{loss,comb} in the vehicle combination 100 can be expressed as:

$${P}_{loss , comb} = {\sum }_{i = 1}^{n} ( {P}_{p i , loss} ( {F}_{pi} ) + {P}_{bi , loss} ( {F}_{bi} ) ) \qquad ( 7 )$$

This formulation can be used as a basis for determining a force control input for the vehicle combination 100 where the total power losses P_{loss,comb} of the vehicle combination 100 are below a threshold, for example minimised. For example, an acceptable value for the total power losses P_{loss,comb} of the vehicle combination 100 can be determined and implemented as an upper limit for the power losses. The force control input can then be determined such that the total power losses of the vehicle combination 100 are below that value, i.e. the force control input corresponds to the cumulative power losses being below the threshold. That is to say, the force control input can be determined such that the total power losses from the batteries 120, the electrical machines 130, the drivetrain, and the service brakes 150 are below a threshold, for example minimised. This may be achieved using an optimisation function to model different force control inputs and minimise the cumulative power losses from the vehicle combination 100.

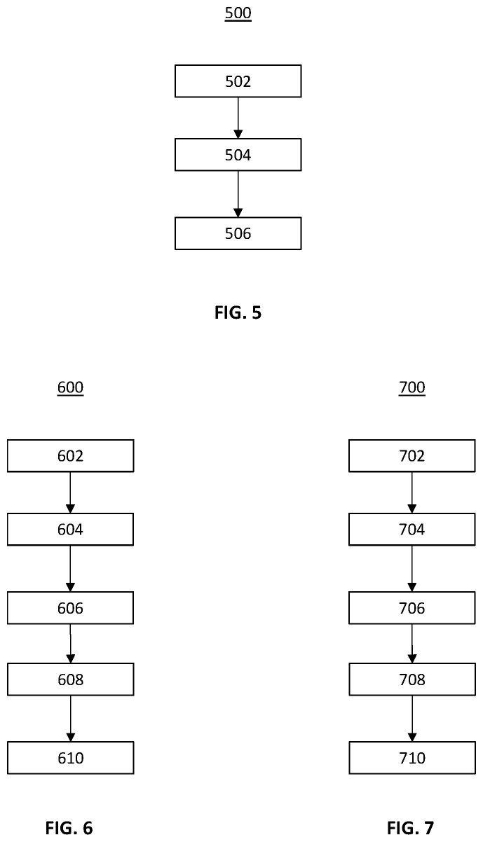

FIG. 5 is a flowchart of an example method 500 for determining a force control input for a vehicle combination 100. The method 500 is a computer-implemented method, performed for example by the control system 200 of a vehicle combination 100.

At 502, a requested reference input r_{req} for the vehicle combination 100 may be determined. As discussed above, the requested reference input may be determined in the target generator 202 of the control system based on an input from a driver or any other system that may provide some indication of how the overall forces of the vehicle combination 100 are to be influenced.

The requested reference input r_{req} may comprise at least one of a longitudinal acceleration aₓ of the vehicle combination 100 as a whole or of a unit 110 of the vehicle combination 100 (for example the unit 110 comprising the combination control allocator 210), a longitudinal velocity vₓ₁ of the tractor unit 110-1, a lateral velocity v_{y1} of the tractor unit 110-1, a yaw rate ω_{zi} of at least one unit 110 of the vehicle combination 100, and a steering angle δ_{f,req} of the tractor unit 110-1. The requested reference input r_{req} may be a vector formulated in one of the following ways:

$${r}_{req} = [ {v}_{x 1} , {v}_{y 1} , {ω}_{z 1} , {ω}_{z 2} , … , {ω}_{zn} ] \qquad ( 8 )$$

$${r}_{req} = [ \begin{matrix}{a}_{x , req} \\ {δ}_{f , req}\end{matrix} ] \qquad ( 9 )$$

$${r}_{req} = [ \begin{matrix}{a}_{x , req} \\ {ρ}_{f , req}\end{matrix} ] \qquad ( 10 )$$

where δ_{f,req} is a driver steering input and β_{f,req} is the path curvature. The requested reference input r_{req} can be converted by the force generator 216 into the force inputs required for the vehicle combination 100, as discussed above.

At 504, respective power losses P_{i,loss} associated with one or more units 110 of the vehicle combination 100 are determined. As discussed above, the power losses P_{i,loss} are a function of the force provided by the unit. The power losses P_{i,loss} may comprise a power loss for the unit's propulsion system P_{pi,loss} and a power loss for the unit's braking system P_{bi,loss}. The selection of units 110 to be considered in 504 can be made by a user. In some examples, it may be desired to consider most or all of the units 110 in a vehicle combination 100. In other examples, for example where the vehicle combination 100 comprises a tractor unit 110-1 having an internal combustion engine (e.g. diesel) and an electric trailing unit 110-2, only the losses of the tractor unit 110-1 may be considered, for example as diesel refuelling is more expensive than electric refuelling.

At 506, a force control input is determined such that a cumulative power loss of the vehicle combination 100 is below a threshold. For example, an acceptable value for the total power losses P_{loss,comb} of the vehicle combination 100 can be determined and implemented as an upper limit for the power losses. The force control input can then be determined such that the cumulative power losses of the vehicle combination 100 are below that value, i.e. the force control input corresponds to the cumulative power losses being below the threshold. This can be achieved using an optimisation function to minimise the cumulative power losses of the vehicle combination 100. Alternatively, this can be achieved, for example, using rule-based methods of machine learning methods.

In the following, only the longitudinal part of the force, Fₓ, is considered for simplicity. However, it will be appreciated that other components of the force can be considered. For example, lateral forces and yaw moments can be obtained indirectly from differential braking and propulsion. Steering control can also be taken into account.

The force control input Fₓ comprises the propulsion and braking components of the force for each unit. As such, the force control input Fₓ can be formulated as:

$${F}_{x} = [ {F}_{xp 1} , {F}_{xb 1} , {F}_{xp 2} , {F}_{xb 2} , ... , {F}_{xpn} , {F}_{xbn} ] \qquad ( 11 )$$

where Fₓₚᵢ is the longitudinal part of the force control input for the unit's propulsion system, and F_{xbi} is the longitudinal part of the force control input for the unit's braking system.

An optimisation function to minimise the cumulative power losses may be formulated based on equation (7), and given as follows:

$${min}_{{F}_{x}} {\sum }_{i = 1}^{n} ( {P}_{pi , loss} ( {F}_{xpi} ) + {P}_{bi , loss} ( {F}_{xbi} ) ) \qquad ( 12 )$$

The optimisation function in equation (12) serves to minimise the cumulative power losses from the batteries 120-i, the electrical machines 130-i, the drivetrain, and the service brakes 150-i. The optimisation function operates by modelling different force control inputs and determining values for Fₓₚᵢ and F_{xbi} that minimise the function. It has been found that the optimization function is typically can be approximated as second order (quadratic) and there are efficient numerical methods to solve this problem.

The optimisation function may be subject to certain constraints. For example, it is ensured that the determined force control input Fₓ meets the reference force input F_{x,tot,req} for the vehicle combination 100, i.e. the force control input fulfills the requested movement of the vehicle combination 100. This can be expressed as follows:

$$[ 111 , ... , 2 n ] {F}_{x} = {F}_{x , tot , req} \qquad ( 13 )$$

It may also be ensured that the optimisation function is constrained by the force capabilities u_{i,cap} of the units of the vehicle combination 100. This can be expressed as follows:

$${F}_{x , cap , min} \leq {F}_{x} \leq {F}_{x , cap , max} \qquad ( 14 )$$

It may also be ensured that the optimisation function is constrained by a safe operating envelope of the vehicle combination 100. This can be expressed as follows:

$${AF}_{x} \leq {b}_{stab} \qquad ( 15 )$$

where the matrix A contains the lines that bounds the safe operating envelope, which may be modelled as a polytope, and b_{stab} is a vector that, in combination with A, defines the inequality constraints. Take the number of constraints in the safe operating envelope as q, then A will have dimensions q x 2n and b_{stab} will have dimension q. The use of safe operating envelope is explained in more detail in PCT patent applications PCT/EP2022/065289 and PCT/EP2022/065297 filed on 6 Jun. 2022 in the name of Volvo Truck Corporation.

As mentioned above, method 500 may also consider components of the force other than the longitudinal component. For example, lateral forces and yaw moments can be obtained indirectly from differential braking and propulsion. Furthermore, the unit control allocators 212 may transmit the total normal forces of the propelled axles F_{zpi} and total normal forces of the braked axles F_{zbi} to the combination control allocator 210. This helps the combination control allocator 210 to distribute the forces more effectively. As such, the optimisation function in equation (12) can be written as follows:

$${min}_{F} {\sum }_{i = 1}^{n} ( {P}_{pi , loss} ( {F}_{pi} ) + {P}_{bi , loss} ( {F}_{bi} ) ) \qquad ( 16 )$$

where F=[Fₚᵢ, F_{bi}].

The unit control allocators 212 may also transmit the road friction coefficient to the combination control allocator 210. For example, the longitudinal force can be limited by the product of the normal load and the coefficient of friction. This can be implemented in the capability definition or in the constraints of the optimisation function. When implemented in the constraints, the inputs to different units can be related to each other, allowing sophisticated safe operating envelopes. For example, it may be ensured that the tractor unit 110-1 does not brake alone with high forces, but that high tractor braking is allowed when a trailer unit 110-i is also sufficiently braked.

The optimisation function in equation (12) may also include weighting factors associated with each unit of the vehicle combination 100. In such a case, the optimisation function may be formulated as follows:

$${min}_{{F}_{x}} {\sum }_{i = 1}^{n} ( {γ}_{pi} \cdot {P}_{pi , loss} ( {F}_{xpi} ) + {γ}_{bi} \cdot {P}_{bi , loss} ( {F}_{xbi} ) ) \qquad ( 17 )$$

where, for each unit i, γₚᵢ is a weighting factor for its propulsion system and γ_{bi} is a weighing factor for its braking system.

The weighting factors γₚᵢ, γ_{bi} can be set as 1 for the base case, but can be set appropriately in order to tune the optimisation function for different outcomes. The weighting factors could be calculated based on current operating conditions, and/or based on future operating conditions by receiving look-ahead information, for example from the tactical layer 204.

In one example, the use of the actuators for a particular unit 110 may be prioritised by setting a weighting factor for that unit with respect to the weighting factor of the other units (with a lower weighting factor underrepresenting the losses from that unit). One example where this may be appropriate is the case of a tractor unit 110-1 having an internal combustion engine (e.g. diesel) and an electric trailing unit 110-2. In this case, it may be desired to focus on propulsion by the tractor unit 110-1 only, for example as diesel refuelling is more expensive than electric refuelling. The weighting factor for the propulsion system of the tractor unit 110-1 can therefore be set relatively high, whereas the weighting factor for the propulsion system of the trailing unit 110-2 can be set relatively low or at zero. This will prioritise minimisation of the power loss of the internal combustion engine.

FIG. 6 is a flowchart of an example method 600 for determining a force control input for a vehicle combination 100. In the method 600, a difference between requested forces and allocated forces across the vehicle combination 100 is taken into account as well as the power losses. The method 600 is a computer-implemented method, performed for example by the control system 200 of a vehicle combination 100. In the following, only the longitudinal part of the force, Fₓ, is considered for simplicity. However, it will be appreciated that other components of the force can be considered.

At 602, a requested reference input r_{req} for the vehicle combination 100 may be determined. The requested reference input r_{req} can be determined as discussed above in relation to 502 in the method 500.

At 604, the requested force input for one or more units of the vehicle combination 100 from the reference input. The requested force input can be given by the unit-specific virtual control inputs uᵢ. The requested force input may comprise a force input for the unit's propulsion system F_{xpi,req} and a force input for the unit's braking system F_{xbi,req}.

At 606, the actual force allocated to one or more units of the vehicle combination 100 is determined. This may include the longitudinal part of the force allocated to the unit's propulsion system Fₓₚᵢ, and the longitudinal part of the force allocated to the unit's braking system F_{xbi}.

At 608, respective power losses P_{i,loss} associated with one or more units 110 of the vehicle combination 100 are determined. As discussed above, the power losses P_{i,loss} are a function of the force provided by the unit. The power losses P_{i,loss} may comprise a power loss for the unit's propulsion system P_{pi,loss} and a power loss for the unit's braking system P_{bi,loss}.

At 610, a force control input is determined such that a cumulative power loss of the vehicle combination 100 and the difference between the requested force and the allocated force of the vehicle combination 100 are below a threshold. For example, an acceptable value for the total power losses P_{loss,comb} of the vehicle combination 100 and an acceptable value for the total force difference of the vehicle combination 100 can be determined and implemented as an upper limit. The force control input can then be determined such that the cumulative power losses and force difference of the vehicle combination 100 are below the sum of the thresholds, i.e. the force control input corresponds to the cumulative power losses and force difference being below the sum of the thresholds. The force difference can be determined for both the propulsion system (F_{xpi,req}−Fₓₚᵢ) and the braking system (F_{xbi,req}−F_{xbi}). This can be achieved using an optimisation function to minimise the cumulative power losses and force difference of the vehicle combination 100. Alternatively, this can be achieved, for example, using rule-based methods or machine learning methods.

An optimisation function to minimise the cumulative power losses and force difference may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {( {F}_{xpi , req} - {F}_{xpi} )}^{2} + {( {F}_{xbi , req} - {F}_{xbi} )}^{2} ) \qquad ( 18 )$$

The optimisation function operates by modelling different force control inputs and determining values for Fₓₚᵢ and F_{xbi} that minimise the function. The optimisation function may be subject to the constraints described in equations (13), (14) and (15). It is noted that the difference terms in equation (18) are squared. This is typical in such error calculations, although not essential, and the different terms may be first order terms or a square-root of summations of squared errors. By using second order terms, the negative and positive errors are penalised equally, and larger errors are penalised more than smaller errors.

The optimisation function in equation (18) serves to minimise the cumulative power losses from the batteries 120-i, the electrical machines 130-i, the drivetrain, and the service brakes 150 as well as minimising the difference between requested forces and allocated forces. By minimising the force difference, it can be ensured that the vehicle combination 100 is accurately following the requested motion input. For example, for a jack-knifing vehicle combination 100 due to too much tractor braking, the requested forces can be set as zero or small, and the minimisation of the function would be achieved by braking a trailer unit 110 more and tractor unit 110-1 less.

Similarly to the optimisation function in equation (12), the optimisation function in equation (18) may also consider components of the force other than the longitudinal component. As such, the optimisation function in equation (18) can be written as follows:

$${min}_{F} {\sum }_{i = 1}^{n} ( {P}_{pi , loss} ( {F}_{pi} ) + {P}_{bi , loss} ( {F}_{bi} ) + {( {F}_{pi , req} - {F}_{pi} )}^{2} + {( {F}_{bi , req} - {F}_{bi} )}^{2} ) \qquad ( 19 )$$

Similarly to the optimisation function in equation (12), the optimisation function in equation (18) may also include weighting factors associated with each unit of the vehicle combination 100. In such a case, the optimisation function may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {γ}_{pi} \cdot {( {F}_{xpi , req} - {F}_{xpi} )}^{2} + {γ}_{bi} \cdot {( {F}_{xbi , req} - {F}_{xbi} )}^{2} ) \qquad ( 20 )$$

where γₚᵢ is a weighting factor for the unit's propulsion system and γ_{bi} is a weighing factor for the unit's braking system. It will be appreciated that weighting factors for the power loss terms may also be used, as explained in relation to equation (17).

The weighting factors γₚᵢ, γ_{bi} can be set as 1 for the base case, but can be set appropriately in order to tune the optimisation function for different outcomes. Setting them as zero will result in power loss minimisation. Setting them as a large number will strictly follow the requested input. Setting them as an intermediate value will provide a trade-off between the two. The weighting factors could be calculated based on current operating conditions, and/or based on future operating conditions by receiving look-ahead information, for example from the tactical layer 204.

In one example, the use of the actuators for a particular unit 110 may be prioritised by setting a weighting factor for that unit with respect to the weighting factor of the other units (with a lower weighting factor underrepresenting the losses from that unit). One example where this may be appropriate is to solve a yaw instability, such as jack-knifing or trailer swing. For example, for jack-knifing that is caused by too much tractor braking, those coefficients corresponding to the tractor unit 110-1 can be increased, so that tractor actuator usage is penalized more, and trailer actuator usage is preferred for braking. A yaw instability can be an ongoing or an upcoming yaw instability. An upcoming yaw instability may be predicted for a given prediction horizon, for example, 1 second. The weighting factors γₚᵢ, γ_{bi} can be set either by directly reading sensor data such as a yaw rate ω_{zi} of at least one unit 110, a side slip angle β of at least one unit 110, a lateral accelerations α_{y} of at least one unit 110, etc., or by using a model-based detection algorithm as explained in PCT patent application PCT/EP2022/069950 filed on 15 Jul. 2022 in the name of Volvo Truck Corporation.

FIG. 7 is a flowchart of an example method 700 for determining a force control input for a vehicle combination 100. In the method 700, a difference between the requested state of energy rate S\dot{o}E_{i,req} and the allocated state of energy rate S\dot{o}Eᵢ across the vehicle combination 100 is taken into account as well as the power losses. The method 700 is a computer-implemented method, performed for example by the control system 200 of a vehicle combination 100. In the following, only the longitudinal part of the force, Fₓ, is considered for simplicity. However, it will be appreciated that other components of the force can be considered.

At 702, a requested reference input r_{req} for the vehicle combination 100 may be determined. The requested reference input r_{req} can be determined as discussed above in relation to 502 in the method 500 or 602 in the method 600.

At 704, the requested state of energy rate S\dot{o}E_{i,req} for one or more units of the vehicle combination 100 is determined. The requested state of energy rate S\dot{o}E_{i,req} can be given by F_{xpi,req}·V_{xi,req} (or indeed F_{xpi,req}·Vₓᵢ)

At 706, the state of energy rate S\dot{o}Eᵢ allocated to one or more units of the vehicle combination 100 is determined. The state of energy rate S\dot{o}Eᵢ can be expressed as Fₓₚᵢ·Vₓᵢ, and so it is also a function of Fₓₚᵢ.

At 708, respective power losses P_{i,loss} associated with one or more units 110 of the vehicle combination 100 are determined. As discussed above, the power losses P_{i,loss} are a function of the force provided by the unit. The power losses P_{i,loss} may comprise a power loss for the unit's propulsion system P_{pi,loss} and a power loss for the unit's braking system P_{bi,loss}.

At 710, a force control input is determined such that a cumulative power loss of the vehicle combination 100 and the difference between the state of energy rate S\dot{o}E_{i,req} and allocated state of energy rate S\dot{o}Eᵢ of the vehicle combination 100 are below a threshold. For example, an acceptable value for the total power losses P_{loss,comb} of the vehicle combination 100 and an acceptable value for the total state of energy rate difference of the vehicle combination 100 can be determined and implemented as an upper limit. The force control input can then be determined such that the cumulative power losses and state of energy rate difference of the vehicle combination 100 are below the sum of the thresholds i.e. the force control input corresponds to the cumulative power losses and state of energy rate difference being below the sum of the thresholds. This can be achieved using an optimisation function to minimise the cumulative power losses and state of energy rate difference of the vehicle combination 100. Alternatively, this can be achieved, for example, using rule-based methods or machine learning methods.

An optimisation function to minimise the cumulative power losses and state of energy rate difference may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {( {\dot{SoE}}_{i , req} - {\dot{SoE}}_{i} )}^{2} ) \qquad ( 21 )$$

The optimisation function operates by modelling different force control inputs and determining values for Fₓₚᵢ, F_{xbi}, and S\dot{o}Eᵢ that minimise the function. When determining the force control input for the propulsion system, the state of energy rate is indirectly determined, as it is a product of the force and the current speed of the vehicle combination 100. It has been found that the optimization function is typically can be approximated as second order (quadratic) and there are efficient numerical methods to solve this problem. The optimisation function may be subject to the constraints described in equations (13), (14) and (15).

The optimisation function in equation (21) serves to minimise the cumulative power losses from the batteries 120-i, the electrical machines 130-i, the drivetrain, and the service brakes 150 as well as minimising the difference between requested state of energy rate S\dot{o}E_{i,req} and the allocated state of energy rate S\dot{o}Eᵢ across the vehicle combination 100. By minimising the state of energy rate difference, it can be ensured that energy management, such as SoC of the various batteries 120, is properly performed. For example, the battery 120 of a unit 110 with higher SoC can be drained for an uphill slope, as batteries 120 of all units 110 can be charged fully with regenerative braking at a following downhill slope.

Similarly to the optimisation function in equations (12) and (18), the optimisation function in equation (21) may also consider components of the force other than the longitudinal component. As such, the optimisation function in equation (21) can be written as follows:

$${min}_{F} {\sum }_{i = 1}^{n} ( {P}_{pi , loss} ( {F}_{pi} ) + {P}_{bi , loss} ( {F}_{bi} ) + {( {\dot{SoE}}_{i , req} - {\dot{SoE}}_{i} )}^{2} ) \qquad ( 23 )$$

Similarly to the optimisation function in equations (12) and (18), the optimisation function in equation (21) may also include weighting factors associated with each unit of the vehicle combination 100. In such a case, the optimisation function may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {{γ}_{i} ( {\dot{SoE}}_{i , req} - {\dot{SoE}}_{i} )}^{2} ) \qquad ( 23 )$$

It will be appreciated that weighting factors for the power loss terms may also be used, as explained in relation to equation (17).

The weighting factor γᵢ can be set as 1 for the base case, but can be set appropriately in order to tune the optimisation function for different outcomes. Setting γᵢ as zero will result in power loss minimisation. Setting γᵢ as a large number will strictly follow the requested state of energy rate. Setting γᵢ as an intermediate value will provide a trade-off between the two. The weighting factor γᵢ could be calculated based on current operating conditions, but also based on future operating conditions by receiving look-ahead information, for example from the tactical layer 204.

The performance enabled by the methods 600 and 700 may alternatively be achieved by changing the capabilities F_{x,cap,min} and F_{x,cap,max} in equation (14), or by imposing new inequality constraints in matrix A in equation (15). Alternatively, in the method 700, SoE targets can be fulfilled via the requested forces instead of requested rate of SoE. For example, as energy is related to the power, which is in turn related to the force, the state of energy difference term in the optimisation function of the method 700 could be replaced by a force difference term in the optimisation function of the method 600. The requested forces coming from both energy management and stability control can then be arbitrated.

The methods 500, 600 and 700 can be combined to determine a force control input for a vehicle combination 100 based on the power losses, for force difference, and the state of energy rate difference of the vehicle combination 100. In such a case, an optimisation function may be formulated as follows:

$${min}_{{F}_{x}} {\sum }_{i = 1}^{n} ( {P}_{pi , loss} ( {F}_{xpi} ) + {P}_{bi , loss} ( {F}_{xbi} ) + {γ}_{pi} \cdot {( {F}_{xpi , req} - {F}_{xpi} )}^{2} + {γ}_{bi} \cdot {( {F}_{xbi , req} - {F}_{xbi} )}^{2} + {{γ}_{i} ( {\dot{SoE}}_{i , req} - {\dot{SoE}}_{i} )}^{2} ) \qquad ( 24 )$$

It will be appreciated that weighting factors for the power loss terms may also be used, as explained in relation to equation (17).

The weighting factors can be set as 1 for the base case, but can be set appropriately in order to tune the optimisation function for different outcomes. Setting them as zero will result in power loss minimisation. Setting them as intermediate values will provide a trade-off to steer the solution to different points. It may be desirable to prioritise stability control over state of energy, as safety is more important than energy efficiency.

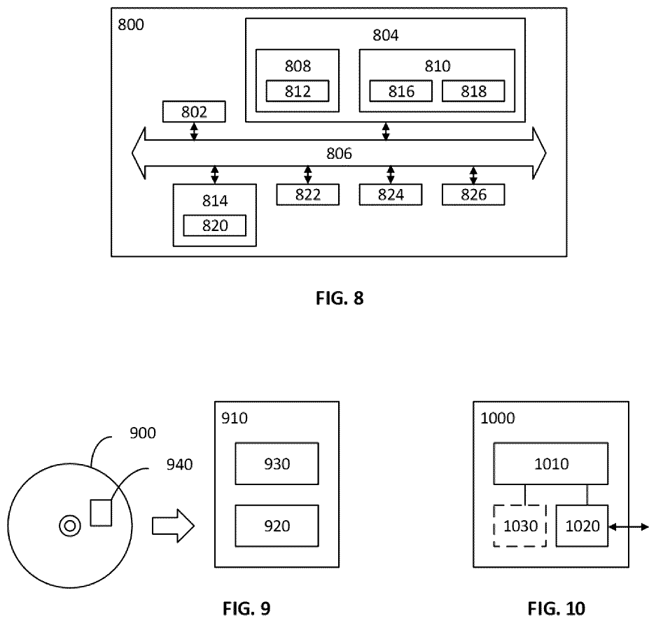

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g., networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilized with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein.

The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

The described examples and their equivalents may be realized in software or hardware or a combination thereof. The examples may be performed by general purpose circuitry. Examples of general purpose circuitry include digital signal processors (DSP), central processing units (CPU), co-processor units, field programmable gate arrays (FPGA) and other programmable hardware. Alternatively or additionally, the examples may be performed by specialized circuitry, such as application specific integrated circuits (ASIC). The general purpose circuitry and/or the specialized circuitry may, for example, be associated with or comprised in an electronic apparatus such as a vehicle control unit.

The electronic apparatus may comprise arrangements, circuitry, and/or logic according to any of the examples described herein. Alternatively or additionally, the electronic apparatus may be configured to perform method steps according to any of the examples described herein.

According to some examples, a computer program product comprises a non-transitory computer readable medium such as, for example, a universal serial bus (USB) memory, a plug-in card, an embedded drive, or a read only memory (ROM). FIG. 9 illustrates an example computer readable medium in the form of a compact disc (CD) ROM 900. The computer readable medium has stored thereon a computer program 940 comprising program instructions. The computer program is loadable into a data processor (e.g., a data processing unit) 920, which may, for example, be comprised in a vehicle control unit 910. When loaded into the data processor, the computer program may be stored in a memory 930 associated with, or comprised in, the data processor. According to some examples, the computer program may, when loaded into, and run by, the data processor, cause execution of method steps according to, for example, any of the methods described herein.

FIG. 10 schematically illustrates, in terms of a number of functional units, the components of a control unit 1000 according to some examples. The control unit may be comprised in a vehicle, e.g., in the form of a vehicle motion management (VMM) unit. A processor device in the form of processing circuitry 1010 is provided using any combination of one or more of a suitable central processing unit (CPU), multiprocessor, microcontroller, digital signal processor (DSP), or similar; capable of executing software instructions stored in a computer program product, e.g. in the form of a storage medium 1030. The processing circuitry 1010 may further be provided as at least one application specific integrated circuit ASIC, or field programmable gate array FPGA.

Particularly, the processing circuitry 1010 is configured to cause the control unit 1000 to perform a set of operations, or steps; for example, the methods discussed in connection with FIGS. 5 to 7.

For example, the storage medium 1030 may store a set of operations, and the processing circuitry 1010 may be configured to retrieve the set of operations from the storage medium 1030 to cause the control unit 1000 to perform the set of operations. The set of operations may be provided as a set of executable instructions. Thus, the processing circuitry 1010 is thereby arranged to execute methods as herein disclosed.

The storage medium 1030 may comprise persistent storage, which, for example, can be any single one or combination of magnetic memory, optical memory, solid state memory or even remotely mounted memory.

The control unit 1000 may further comprise an interface 1020 for communication with at least one external device. As such, the interface 1020 may comprise one or more transmitters and receivers, comprising analogue and digital components and a suitable number of ports for wireline or wireless communication.

The processing circuitry 1010 controls the general operation of the control unit 1000, e.g., by sending data and control signals to the interface 1020 and the storage medium 1030, by receiving data and reports from the interface 1020, and by retrieving data and instructions from the storage medium 1030. Other components, as well as the related functionality, of the control node are omitted in order not to obscure the concepts presented herein.

In some examples, the control unit 1000 may be seen as a control system, or may be comprised in a control system. The control system may be configured for vehicle motion management (VMM).

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer-implemented method for determining a force control input for a vehicle combination comprising a tractor unit and at least one trailing unit, the method comprising, by processing circuitry of a computer system:
receiving a reference input representing a requested movement of the vehicle combination;
determining a requested state of energy rate for each unit of the vehicle combination;
determining a state of energy rate allocated to each unit of the vehicle combination;
determining respective power losses associated with each unit of the vehicle combination, wherein the power losses are a function of a force provided by the unit; and
determining the force control input using an optimisation function to minimise a sum for the vehicle combination of a cumulative power loss and a cumulative difference between the requested state of energy rate and the allocated state of energy rate;
wherein a state of energy rate is a product of the respective force and velocity; and the determined force control input meets the reference input for the vehicle combination.

2. The computer-implemented method of claim 1, wherein the power losses associated with a unit comprise power losses for the propulsion system of the unit and/or power losses for the braking system of the unit.

3. The computer-implemented method of claim 1, wherein the power losses associated with a unit comprise at least one of a power loss associated with a battery of the unit, a power loss associated with an electrical machine of the unit, a power loss associated with the drivetrain of the unit, and a power loss associated with service brakes of the unit.

4. The computer-implemented method of claim 1, wherein the difference between the requested state of energy rate and the allocated state of energy rate for a unit comprises a difference for the propulsion system of the unit and a difference for the braking system of the unit.

5. The computer-implemented method of claim 1, wherein the force control input comprises a force control input for each unit of the vehicle combination.

6. The computer-implemented method of claim 1, wherein the force control input comprises a force control input for the propulsion system of at least one unit of the vehicle combination and a force control input for the braking system of at least one unit of the vehicle combination.

7. (canceled)

8. The computer-implemented method of claim 1, wherein the optimisation function is given by:
$${min}_{F} {\sum }_{i = 1}^{n} ( {P}_{pi , loss} ( {F}_{pi} ) + {P}_{bi , loss} ( {F}_{bi} ) + {( {\dot{SoE}}_{i , req} - {\dot{SoE}}_{i} )}^{2} )$$
Where, for each unit i, P_{pi,loss} is the power loss for propulsion, a P_{bi,loss} is the power loss for braking, Fₚᵢ is a force control input for the unit's propulsion system, F_{bi} is a force control input for the unit's braking system, S\dot{o}E_{i,req} is the requested state of energy rate, S\dot{o}Ei is the allocated state of energy rate, and F=[Fₚᵢ, F_{bi}].

9. The computer-implemented method of claim 1, wherein the optimisation function is constrained by the force capabilities of the units of the vehicle combination.

10. The computer-implemented method of claim 1, wherein the optimisation function is constrained by a safe operating envelope of the vehicle combination.

11. The computer-implemented method of claim 1, wherein the optimisation function comprises weighting factors associated with one or more units of the vehicle combination.

12. The computer-implemented method of claim 11, wherein the weighting factors comprise weighting factors for the unit's propulsion system and weighting factors for the unit's braking system.

13. The computer-implemented method of claim 11, wherein the weighting factors are determined based on current or future operating conditions of the vehicle combination.

14. The computer-implemented method of claim 1, wherein the optimisation function comprises a term for the difference between requested forces and allocated forces across the vehicle combination.

15. The computer-implemented method of claim 1, wherein the reference input comprises at least one of a longitudinal acceleration of the vehicle combination, a longitudinal acceleration of at least one a unit, a longitudinal velocity of the tractor unit, a lateral velocity of the tractor unit, a yaw rate of at least one unit of the vehicle combination, and a steering angle of the tractor unit.

16. A vehicle combination comprising a tractor unit and at least one trailing unit, the vehicle combination comprising processing circuitry to perform the computer-implemented method of claim 1.

17. A computer program product comprising program code for performing, when executed by processing circuitry, the computer-implemented method of claim 1.

18. (canceled)

19. A non-transitory computer-readable storage medium comprising instructions, which when executed by processing circuitry, cause the processing circuitry to perform the computer-implemented method of claim 1.

20. A computer system comprising processing circuitry configured to perform the computer-implemented method of claim 1.
